(19) United States
(12) Patent Application Publication
(10) Pub. No.: US 2014/0104067 A1
(43) Pub. Date: Apr. 17, 2014

(54) Smoke Sensor

(71) Applicant: Hui-Chuan Chien, Taipei (TW)

(72) Inventor: Hui-Chuan Chien, Taipei (TW)

(73) Assignee: Jung-Tang Huang

(21) Appl. No.: 13/653,361

(22) Filed: Oct. 16, 2012

(51) Int. Cl. G08B 17/10

(52) U.S. Cl. CPC G08B 17/10
USPC 340/628

(57) ABSTRACT

A smoke detector with an input port belonging to an existing light fixture, the input port connected to a housing and electrically to an AC to DC converter. The housing accommodates a communication module such as Bluetooth and/or WIFI operable to act as a node, a microprocessor, and a smoke detecting unit. When the smoke detecting unit detects hazardous smoke emitted from environment over a threshold, it can wirelessly issue alarm and notify the persons nearby and people in charge.

### FIELD OF INVENTION

A smoke sensor, in particular, with an input port belong to a standard bulb connector or lamp connector which undertakes a container and electrically connects to an AC to DC circuit module, a wireless communication module, a microprocessor, a smoke sensing unit, when detect abnormal environment smoke warning is issued to notify the relevant personnel through wireless communications.

### DESCRIPTION OF RELATED ART

Due to general considerations of fire safety, there are many indoor places need to install smoke sensors, however, many old buildings often do not reserve installation position or power connector for smoke detector. Besides, the regular smoke sensor does not have a wireless or wired communication capability, usually just warn or link sprinklers to perform sprinkle function after detecting smoke.

In addition, because of the poor indoor ventilation, and if there are supply source of natural gas or carbon monoxide, such as a gas leak or incomplete combustion or incomplete burning of carbon, it may often cause gas or carbon monoxide poisoning. Although there is a gas leak or carbon monoxide detectors, due to non-compulsive in the fire safety regulations, installation is not popular, and the installation is not easy.

Furthermore, indoor even many campuses are non-smoking area, some preferences smokers often cannot overcome the cravings, may gather in the stairs or toilets to smoke, which is against smoking law. Some smoking within the park may lead to littering of cigarette butts, which may lead to dead ends of park management. Even if the installation of cameras is directly to monitor whether the smoker is smoking it is still not easy to take advantage of photography at any time since the processing of the captured video is too complex and time consuming.

The above issues really need an innovative device to solve.

### SUMMARY

Accordingly, the purpose of the present invention is to provide a smoke sensor with a standard bulb holder or lamp seat with or without LED devices.

The present invention provides smoke sensors built in the LED bulbs or tubes with a standard bulb holder or light tube holder such that users can install their own smoke sensors by just replacing the regular bulb or light tube.

The present invention provides the function that cigarette smoke is identified by smoke sensor first, and then it can provide a warning through the LED blinking or slow dimming. Further a wireless IP camera installed in or around the smoke sensor may be used to recognize the cigarette smoker after the remote monitoring personnel or security personnel identify the excess cigarettes concentrations.

In summary, the invention is to provide a smoke sensor integrated with LED bulbs or tubes, the smoke sensor can detect abnormal environment smoke and issue warning, through the built-in Bluetooth communication modules or other wireless communication way to notify the fire unit or building personnel, further enables LED alarm blinking or brightness changes to elevate nearby personnel alertness; through this combination, smoke sensors without additional power connector, just through any lamp or fluorescent lamp connector, users can install the invented smoke sensors easily.

### BRIEF DESCRIPTION OF DRAWINGS

The detailed drawings of this invention will be fully understood from the Following descriptions wherein:

FIG. 1 shows the schematic diagram of a light bulb type smoker sensor integrated with LED.

FIG. 2 shows the two kinds of universal bulb adapters.

FIG. 3 shows an embodiment of a smoke sensor circuit.

FIG. 4 shows a light tube type smoke sensor of the present invention.

### DETAILED DESCRIPTION

The following description should be read with reference to the drawings, in which like elements in different drawings are numbered in like fashion. The drawings, which are not necessarily to scale, depict selected embodiments and are not intended to limit the scope of the invention. Although examples of construction, dimensions, and materials are illustrated for the various elements, those skilled in the art will recognize that many of the examples provided have suitable alternatives that may be utilized.

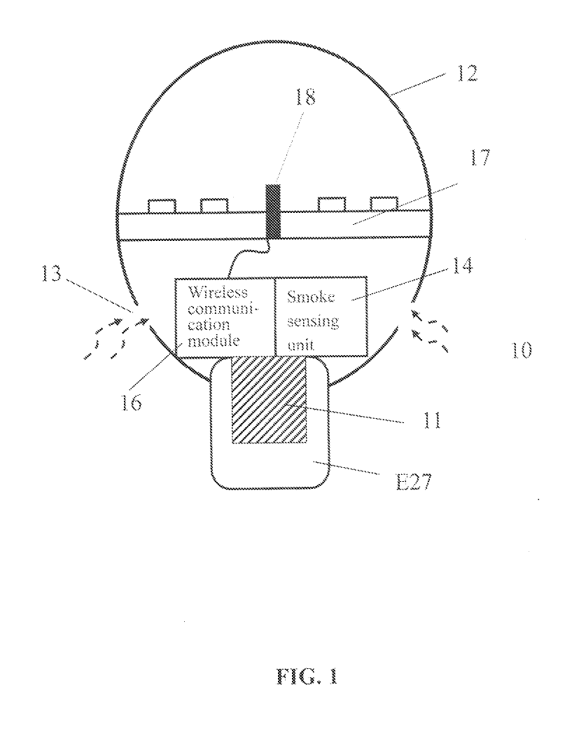

As shown in FIG. 1, a smoke sensor 10 is integrated in the LED light bulb 12 or tubes, a standard lamp connector E27 is electrically connected to an AC to DC circuit module 11 which is employed to convert the city power into DC power for supplying power to the other electronic components inside the smoke sensor. The part near the connector E27 of the LED bulb has cooling holes 13 just for providing a diffusion pipeline of the air around the bulb. The smoke sensing unit 14 is able to detect the ambient gas through the cooling holes 13. If the ambient gas contains unusual ingredients, the smoke sensor 10 may issue warning through Bluetooth communications or other types of wireless communication module 16 to notice gateway within the building, then via internet for directly reporting to the Fire units or personnel within the building. It may further enable the LED warning with the flashing, or augment a buzzer with a warning beep. Bluetooth communication module antenna 18 can pass through the circuit board with LED dies 17 and heat sink module. Through the above combination, the invented smoke sensors without additional power connector, any lamp or fluorescent light fittings, may be installed with the replacement of existing lamps or tubes. Further, the installation of a battery can provide power to the smoke sensor for continuing operation as a power outage. Furthermore, the addition of a charging circuit consisting essentially of AC to DC circuit module 11 to charge the battery may eliminate the frequent issue of replacing the battery in conventional smoke sensors.

There are two common types of smoke sensing unit 14. Their working principles are described below:
(1) Optical smoke sensing unit: a part of its internal structure will emits a light beam and this light can be sensed by another part; When smoke appears, the smoke particles through the beam will block and reflect part of the light source, thus the sensor will immediately detect the anomalies.

(2) Ionization smoke sensing unit: The principle is different from the optical smoke detector. It is an inductor, which can measure the smoke particles smaller than the optical sensor can measure. It has a small cavity in its interior, the air in the cavity is ionized, and thus it can pass the weak current. When smoke appears, the smoke particles move into the cavity, so that resistance in the cavity becomes large and the current is reduced; the decrease of the current is detected by microchip detector, which is regarded as abnormal.

Although the common smoke sensing unit is selected from the group consisting of optical smoke sensing unit, and ionization smoke sensing unit, the carbon monoxide sensing unit and the gas sensing unit also can be used as smoke sensing unit.

General building power supply is 110-220V, and therefore a smoke sensor needs to provide an AC to DC circuit modules, mainly the 3-5V DC power to supply a wireless communication module, a microprocessor, and a smoke sensing unit the required electric power. Since it functions as a smoke sensor, basically as soon as it is connected to the lamp holder, it should immediately begin to operate as long as there is no power outage and can continue to operate without being controlled by the light switch, which means that it must set up an internal switching device. As long as the switch on the wall does not close, the switching device can maintain the operation of the smoke sensor. The additional LED lights can be controlled by a switch on the wall, and can also be regulated by the wireless communication module. That means the preferred operational mode of the embodiment is to make the switch on the wall to maintain conduction, LED lights are regulated by remote control or mobile phone, thus the smoke sensor can continue its operation. Unless it is absolutely necessary before using the switch on the wall to cut off all power to make LED lights and smoke sensors stop. The purpose of the invention of the internal switching device can be achieved by a microprocessor. To take advantage of the switch on the wall, the internal switching means can be achieved by use of multi-stage electronic switching.

Of course, as described above, another solution may be to provide a rechargeable battery in the period of power-off or power failure for maintaining the operation of the smoke sensor and the wireless communication module.

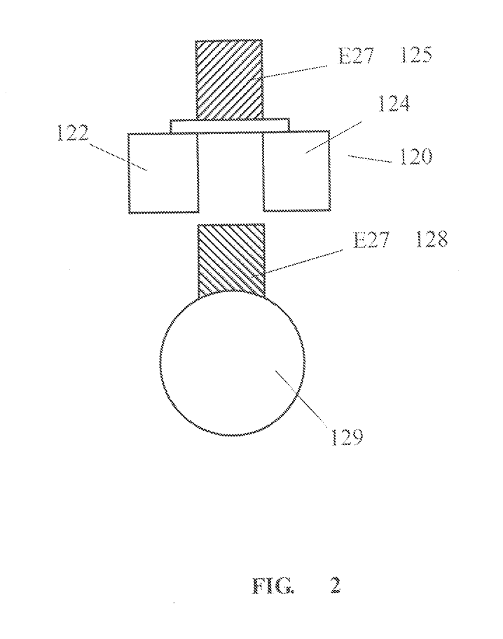

As shown in FIG. 2, a universal bulb adapter 120, comprises an AC-to-DC circuit module 122, a wireless communication module 124, and an input port of the E27 standard bulb connector 125.

Further the universal bulb adapter 120 is added with a dimming or toning circuit module (not shown in the Figure), and provides another output port which is also E27 standard bulb connector 128 and can be connected to a LED bulb 129.

Further a smoke sensor 10 (not shown in the Figure) is added in the universal bulb adapter 120. If the ambient gas contains unusual ingredients, the smoke sensor 10 may issue warning through Bluetooth communications or other types of wireless communication module 124 to notice gateway within the building then via internet directly report to the Fire units or personnel within the building, further enable the LED warning with the flashing, or augment a buzzer warning beep. Through the above combination, the invented smoke sensors without additional power connector, any lamp or fluorescent light fittings, may be installed with the replacement of existing lamps or tubes.

Wireless communication module refers to Bluetooth communications, Bluetooth Low Energy (BLE), Zigbee, WiFi or other band wireless communication specification. Preferred embodiment is selected from Bluetooth, BLE or WIFI or the combination into a network, Bluetooth and WIFI are easy ways to build communication with indoor desktop, laptop, tablet PC, or phone.

For the case of defecting smoking in a non-smoking area, first cigarette smoke is identified by smoke sensor, so it can provide a warning through the LED blinks or slowly dims. Further a wireless IP camera installed in or around the smoke sensor may be triggered to recognize the cigarette smoker after the remote monitoring personnel or security personnel identify the excess cigarette concentrations.

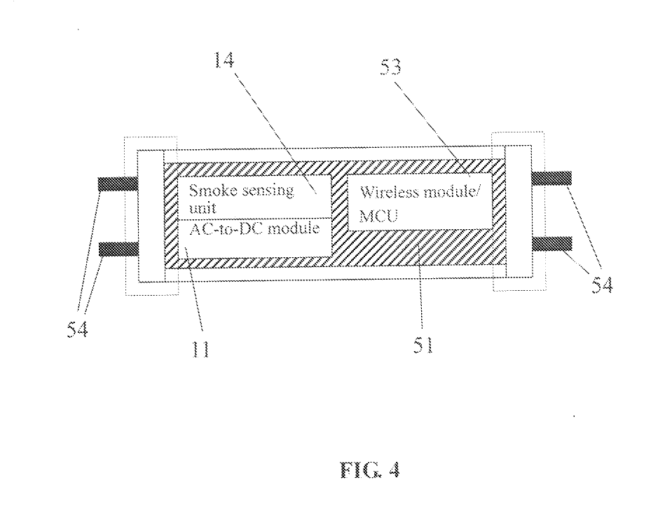

The embodiment of the present invention in the standard fluorescent tubes is shown in FIG. 4. As bulb type smoke sensor in FIG. 1, a standard fluorescent tube fitting 54 is electrically connected to an AC to DC circuit module 11 which is employed to convert the city power into DC power for supplying power to the other electronic components. The part near the connector of LED tube has cooling holes (not shown in the Figure) just for providing a diffusion pipeline of the air around the bulb. The smoke sensing unit 14 is able to detect the ambient gas through the cooling holes. If the ambient gas contains unusual ingredients, the smoke sensor may issue warning through Bluetooth communications or other types of wireless communication module and microcontroller 53 to notice gateway within the building then via internet for directly reporting to the Fire units or personnel within the building. It may further enable the LED warning with the flashing, or augment a buzzer with a warning beep. The above relevant circuit module can be set on the substrate circuit board with LED module 51.

### EXAMPLE OF EMBODIMENT

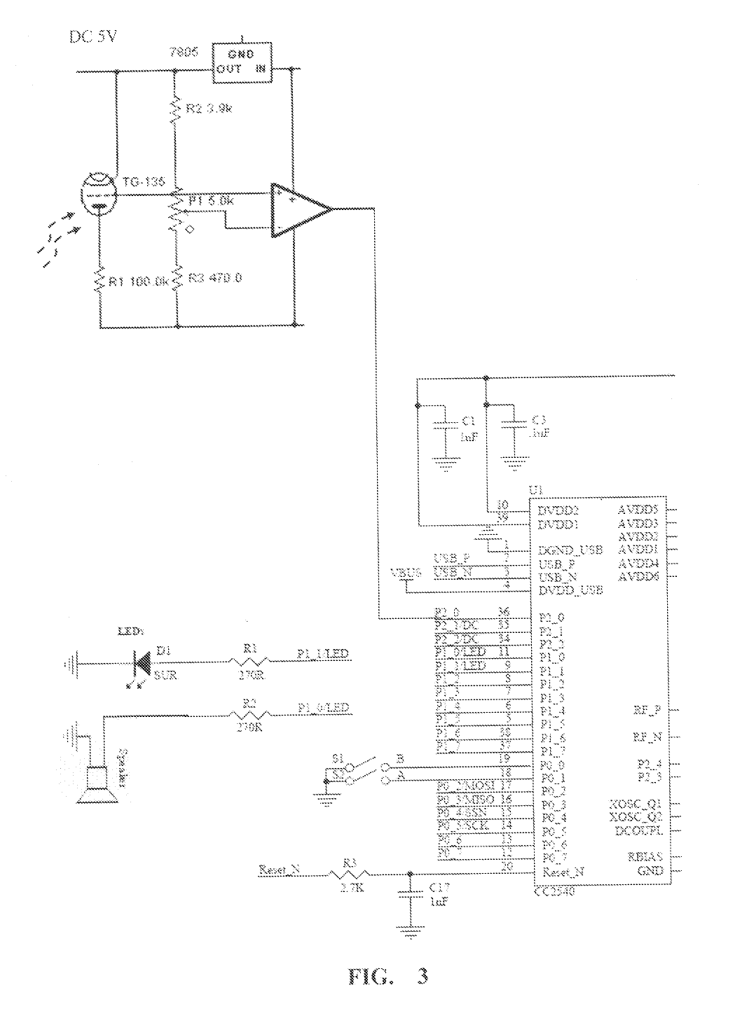

FIG. 3 shows a circuit diagram of the smoke sensing unit connected with TI CC2540/CC2541, are described below:
1. First, VCC is connected to DC5V for supplying power to the smoke sensing unit.

2. Warm-up circuitry: TG-135 (smoke sensing unit) needs 1-2 minutes of warm-up time before the normal action, which is controlled by a warm-up program in the MCU8051 of Texas Instruments SOC chip CC2540/CC2541. When the smoke sensor is switched on, it will start counting 90 seconds before reading the output results of the comparator.

3. Sensing start-up circuit: After TG-135 (smoke sensing unit) is warm-up, the voltage of R1 is dropped a predetermined value of about 0.3˜2V range, depending on the properly of the TG-135. When the green light is turned on, the next step is to adjust P1 for taking away the static DC voltage of R1. By adjusting P1 to let negative pin of IC-a have a voltage slightly higher than the positive pin with an approximate value of 0.2V, the sensitivity of TG-135 (smoke sensing unit) is at the best status. When the quality of the air inside the house is poor (such as smoking) the positive pin voltage of IC-a is increased, the IC-a output is at an H state, and the MCU8051 of the TI CC2540 will start to turn on the D1 LED red light, also start the buzzer (speaker) to issue warning sounds. By wireless communication of the Bluetooth Low Energy provided from CC2540 to transmit signals through the gateway within the building onto Internet, the alarm can be distributed and reported to the Fire unit or building personnel.

Having thus described the several embodiments of the present invention, those of skill in the art will readily appreciate that other embodiments may be made and used which fall within the scope of the claims attached hereto. Numerous advantages of the invention covered by this document have been set forth in the foregoing description. It will be understood that this disclosure is, in many respects, only illustrative. Changes may be made in details, particularly in matters of shape, size and arrangement of parts without exceeding the scope of the invention.

What is claimed is:

1. A smoke sensor comprising:
an input port belonging to a connector of standard light bulb or tube, which is mechanically connected a housing for accommodating:
an AC to DC circuit module electrically connected to the input port;
a smoke sensing unit for sensing abnormal environment smoke;
a microprocessor for the control and operation, and electrically connected to the smoke sensing unit;
the AC to DC circuit module is for supplying DC power to the smoke sensing unit and the microprocessor; when abnormal environment smoke is detected, warning is issued.

2. The smoke sensor of claim 1, wherein she smoke sensing unit of the smoke sensor is selected from the group consisting of optical smoke sensing unit, ionization smoke sensing unit, carbon monoxide sensing unit, and natural gas sensing unit.

3. The smoke sensor of claim 1, wherein further electrically connected to the at least one LED die with its drive circuit and thermal dissipation module.

4. The smoke sensor of claim 1, wherein further comprising a battery for continuing action of smoke sensing as a power outage.

5. The smoke sensor of claim 4, wherein further comprising a charging circuit to charge the battery, basically through the AC to DC circuit module to provide the charging power for eliminating the frequent issue of replacing the battery in conventional smoke sensors.

6. The smoke sensor of claim 3, wherein when abnormal environment smoke is detected, the microprocessor issues warning by driving LED dies blinking.

7. A smoke sensor comprising;
an input port belonging to a connector of standard light bulb or tube, which is mechanically connected a housing for accommodating:
an AC to DC circuit module electrically connected to the input port;
a smoke sensing unit for sensing abnormal environment smoke;
a microprocessor for the control and operation, and electrically connected to the smoke sensing unit; and
a wireless communication module electrically connected with the microprocessor;
the AC to DC circuit module is for supplying DC power to the smoke sensing unit, the microprocessor, and the wireless communication module; when abnormal environment smoke is detected, the microprocessor issues a warning through the wireless communication to notify the relevant personnel.

8. The smoke sensor of claim 7, wherein the smoke sensing unit of the smoke sensor is selected from the group consisting of optical smoke sensing unit, ionization smoke sensing unit, carbon monoxide sensing unit, and natural gas sensing unit.

9. The smoke sensor of claim 7, wherein further electrically connected to the at least one LED die with its drive circuit and thermal dissipation module.

10. The smoke sensor of claim 9, wherein the LED dies are further electrically connected to a dimming or toning circuit module, when abnormal environment smoke is detected, the microprocessor issues commands to the dimming or toning circuit module to blink the brightness or color of the LED lights for generating a smoke alarm.

11. The smoke sensor of claim 7, wherein further comprising a battery for continuing action of smoke sensing as a power outage.

12. The smoke sensor of claim 11, wherein further comprising of a charging circuit to charge the battery, basically through the AC to DC circuit module to provide the charging power for eliminating the frequent issue of replacing the battery in conventional smoke sensors.

13. The smoke sensor of claim 7, wherein the wireless communication module is selected from the group consisting of Bluetooth, Bluetooth Low Energy, Zigbee, WIFI, or other band wireless communication specification.

14. The smoke sensor of claim 13, wherein the wireless communications module is selected from the group consisting of Bluetooth, Bluetooth Low Energy, WIFI, and the combination, which is communicated with desktops, laptops, tablet PCs, or cell phones into a network.

15. The smoke sensor of claim 7, wherein when ambient gas containing unusual ingredients is detected, a warning is broadcasted on the Internet through the gateway of the building network by microprocessor and wireless communication module to directly notify the Fire units or persons in the building.

16. The smoke sensor of claim 7, wherein further comprising a wireless IP camera, which is triggered by remote monitoring or security people for image recognition when cigarette concentration exceeds the threshold around the IP camera.
